(19) United States
(12) Patent Application Publication
(10) Pub. No.: US 2010/0145512 A1
(43) Pub. Date: Jun. 10, 2010

(54) Method and system for transmitting robot control instructions

(76) Inventor: Andy Flessas, Las Vegas, NV (US)

Correspondence Address: WEIDE & MILLER, LTD., 7251 W. LAKE MEAD BLVD., SUITE 530, LAS VEGAS, NV, 89128, US

(21) Appl. No.: 12/658,442

(22) Filed: Feb. 4, 2010

Related U.S. Application Data
(63) Continuation-in-part of application No. 12/455,638, filed on Jun. 3, 2009.
Application No. 12/455,638 is a continuation of application No. 11/700,535, filed on Jan. 30, 2007, now Pat. No. 7,545,108.
(60) Provisional application No. 60/763,669, filed on Jan. 31, 2006.

(51) Int. Cl. G06F 19/00

(52) U.S. Cl. 700/245

(57) ABSTRACT

A robot is controlled by robot control instructions. The instructions may be generated remotely and then carried by or with another signal to the robot. In one embodiment, the robot control instructions are multiplexed with a media stream such as video and/or audio data. The multiplexed signal may be transmitted over an existing media distribution network such as a cable television network. The delivered instructions may be obtained from the feed and be used to control or re-program the robot and the media feed may be used in association with media devices operated synchronously with the robot.

### RELATED APPLICATION DATA

This application is a continuation-in-part of U.S. application Ser. No. 12/455,638, filed Jun. 3, 2009, which is a continuation of U.S. application Ser. No. 11/700,535, filed Jan. 30, 2007, now U.S. Pat. No. 7,545,108, which claims priority to U.S. Provisional Patent Application Ser. No. 60/763,669 filed Jan. 31, 2006.

### FIELD OF THE INVENTION

The present invention relates to robots and method and systems for controlling robots.

### BACKGROUND OF THE INVENTION

The use of robots is becoming increasingly common. Robots are used for a variety of purposes, particularly in the manufacturing industry where they are capable of performing repeated tasks.

One issue that limits the use of robots is the ability to control and re-program them. In a large industrial plant a robot may be programmed for a task and perform that task for years. If the robot is needed for another task, the robot can be programmed directly at the plant for its new task. This may require the skills of specialized programmers, but the costs associated with acquiring such personnel are justified in these settings.

However, for robots to be useful in more common settings, such as retail establishments, homes and the like, these problems must be overcome. It is not practical for a homeowner or small business operator to try and program or re-program a robot, or to hire specialized personnel for such a task.

### SUMMARY OF THE INVENTION

The invention is a method and system for providing robot control instructions. In one embodiment of a method, robot control instructions are generated at a first location, those instructions are associated with media data, the media data including robot control instructions is transmitted via one or more communication links to a remotely located robot, and those instructions are used to control the robot.

In one embodiment of a system, a master controller is configured to generate robot control instructions, a multiplexer multiplexes the robot control instructions and media data and the instructions and data are communicated from the multiplexer and a robot controller via a communication link which preferably comprises at least an existing media distribution network.

The robot control instructions might comprise machine readable/executable code and/or data such as location points or movement codes which can be used by control software to move the robot.

The media data may comprise video and/or audio information, such as streaming audio and/or video. The media distribution network may comprise, for example, an existing cable television distribution network.

The robot controller may comprise a local controller such as a computer having a processor and a memory. In one embodiment, a de-multiplexer is utilized to de-multiplex the robot control instructions from the media data. The media data may be provided to one or more media devices, such as video displays. In this manner, the robot may move synchronously with displayed or presented media.

The method and system may be utilized to provide robot control instructions or otherwise control robot having various configurations. In embodiment, a robot comprises at least one element or member which is moveable by a control mechanism, such as comprising a motor.

As one example, a robot may be configured to support one or more electronic video displays and move the one or more displays in at least two dimensions or directions, and preferably in three-dimensions. In one embodiment, such a robot may comprise a base and a movable support. The base supports the moveable support, such as by resting upon a support surface or by connection to a support, such as a wall or other element.

The moveable support is movable in at least two, and preferably three, dimensions, whereby one more displays connected thereto are so movable. In one embodiment, the moveable support comprises a plurality of members which are movably connected to one another in one more directions/dimensions. The moveable support may comprise, for example, a robotic arm having a base, a main support which is rotatable relative to the base, a lower arm which is rotatable relative to the main support, an upper arm which is rotatable relative to the lower arm, and a head to which the one or more displays are connected, the head movable relative to the upper arm.

In one embodiment, means are provided for moving the robot, such as the moveable support. Preferably, the means permits the display support to be “automated” in the sense that it can be moved without direct physical contact by a human therewith. This means may comprise one or more electric motors or the like.

Further objects, features, and advantages of the present invention over the prior art will become apparent from the detailed description of the drawings which follows, when considered with the attached figures.

### DESCRIPTION OF THE DRAWINGS

FIG. 1 illustrates one embodiment of a robot that may be controlled in accordance with the method and system of the invention, the robot configured to move at least one electronic video display; and

FIG. 2 illustrates one embodiment of a system for controlling a robot in accordance with the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the invention comprises methods and systems for controlling robots, including transmitting control instructions to one or more robots.

The methods and systems herein may be applied to various robots. An example of one robot and use of that robot will now be described. This example comprises a robotically-controlled electronic video display. This robotically-controlled electronic video display might be used in various settings or environments, such as a retail establishment, a casino, a home or the like.

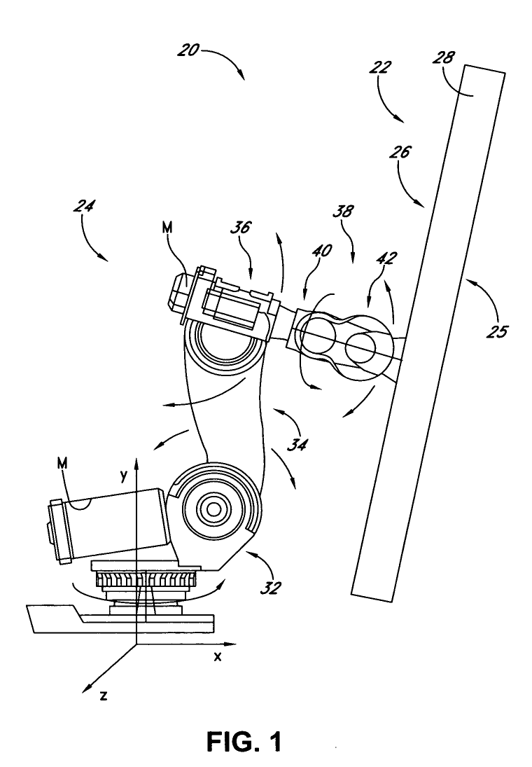

FIG. 1 illustrates one embodiment of a robot 24. In one embodiment, the robot 24 comprises a base and a support. The base is configured to connect or support the robot 24 to a support structure and the support is preferably movable relative to the base.

Referring to FIG. 1, the base 30 may have a variety of configurations, including various shapes and sizes. In general, the base 30 is configured to be mounted to or supported by a support surface, such as a wall, floor or other support, such as a portion of another object. The base 30 may have a generally planar bottom or lower surface for engaging a generally planar support surface, or may have other configurations for engaging support surfaces of other shapes. In one embodiment, the base 30 may include one or more apertures for accepting fasteners which are placed into engagement with the support surface, for securing the base 30 in a fixed position by temporarily or permanently connecting the base 30 to that surface. For example, the base might comprise one or more brackets or the like for mounting the robot to a wall.

In a preferred embodiment, a movable support is connected to the base 30. This support is preferably moveable in at least two (2), and more preferably three (3), dimensions. By “two” or “three-dimensions” it is preferably meant the standard Cartesian two or three-dimensional space, such that the support is capable of moving the display about, or relative to, at least two of an “x”, a “y” and a “z” axis.

As illustrated, in one embodiment, the moveable support is a robotic arm which includes a main support 32. In one embodiment, the main support 32 is mounted for rotation relative to the base 30, i.e. about the “y”-axis as illustrated in FIG. 1. The main support 32 may be mounted, for example, on a bearing supported shaft which is connected to the base 30, or by other means.

In one embodiment, a lower arm 34 is rotatably mounted to the main support 32. As illustrated, the main support 32 has a first portion mounted to the base 30 and a second portion to which the lower arm 34 is mounted. In a preferred embodiment, the lower arm 34 is rotatably mounted to the main support 32 about a shaft or other mount. In the configuration illustrated, the lower arm 34 is mounted for rotation about a “z”-axis (i.e. an axis which is generally perpendicular to the axis about which the base 30 rotates).

As further illustrated, an upper arm 36 is rotatably mounted to the lower arm 34. In one embodiment, a first or distal portion of the lower arm 34 is mounted to the main support 32, and the upper arm 36 is mounted to a top or proximal portion of the lower arm 34. In one embodiment, the upper arm 36 is also mounted for rotation about the “z” axis.

In one embodiment, a head 38 is located at a distal portion of the upper arm 36. Preferably, the display 25 is mounted to the mount 24 via the head 38. In one embodiment, the head 38 is mounted for rotation relative to the upper arm 36 (and thus the remainder of the mount 24). In one configuration, a first portion 40 of the head 38 is mounted for rotation about an “x” axis relative to the upper arm 36 (i.e., about an axis which is perpendicular to both the “y” and “z” axes, and thus about an axis which is generally perpendicular to the axis about which the main support 32 and upper and lower arms 36, 34 rotate).

Further, in the embodiment illustrated, a second portion 42 of the head 38 is mounted for rotation relative to the first portion 40 and the upper arm 36, about the “z”-axis. As illustrated, the display 22 is mounted to the second portion 42 of the head 38.

The various portions of the robot 24 may be connected to one another in a variety of fashions. For example, the various portions may be connected to one another via a shaft and bearing mount, where the shaft is connected to one component and engages one or more bearings supported by the other component, such that the shaft may move relative to the bearing(s), thus permitting the components to move relative to one another. The portions of the mount 24 might be mounted to one another in other fashions, however, such as by hinged mounting, slides, extending arms or the like.

Preferably, the robot 24 includes means for moving the one or more portions thereof. As illustrated, the robot 24 may include one or more motors M for moving the components thereof. The motors M may be electrical motors. In other embodiments, hydraulics or other means may be utilized to move one or more of the components of the robot 24. For example, a hydraulic arm might be utilized to move the upper arm 36 relative to the lower arm 34 in an up and down direction.

The robot 24 may be configured for a variety of tasks. FIG. 1 illustrates an embodiment of a robotically controlled electronic display 20. In this configuration, the robot 24 is configured to support and move at least one electronic video display 20. In a preferred embodiment, the at least one electronic display 22 is a thin-panel type display, such as an LCD, LED, plasma or similar display (whether now known or later developed). In one embodiment, the electronic display 22 has a front or viewing side 25 and an opposing rear side 26. The electronic display 22 has a peripheral edge 28. In one embodiment, the electronic display 22 is generally rectangular in shape, but the display 22 may have a variety of shapes. The electronic display 22 may have a display area at the front side 25, which display area is enclosed by a bezel, frame or the like. The display area comprises the portion of the electronic display 22 which is capable of displaying information. In a preferred embodiment, the electronic display 22 is relatively large, such as for viewing by person situation remotely there from. The electronic display 22 may be 20 inches in diagonal size (of display area), more preferably at least 36 inches in diagonal size, and even more preferably a least 50-60 inches or more in diagonal size.

The electronic display 22 is supported by the robot 24. In a preferred embodiment, the robot 24 is moveable, thus permitting the position of the electronic display 22 to be changed. In a preferred embodiment, the robot 24 is a robot which can change the position of the display in at least two (2), and preferably three (3), dimensions.

The robot 24 may have a variety of other configurations and be configured to support various other items and/or perform other tasks. For example, in the embodiment just described, the robot 24 is configured to move the display 22 in three-dimensions, or combinations thereof. The particular configuration of the robot 24 may vary for accomplishing this task. For example, while the mount 24 described above is “redundant” in its capacity to move in certain directions (i.e. the upper and lower arms 36,34 are both configured to move about the “z” axis), the mount 24 could be configured in other fashions (such as by having only a single portion configured to move in each direction). It will also be appreciated that the number of members or elements which the robot comprises may vary. For example, the robot might comprise a base and a head which is mounted to the based, such as via a swivel, permitting the head to be moved in at least two dimensions. Various configurations of members may also be utilized to effect movement in various directions. For example, aside from swivels or the rotating connections of the robot illustrated in FIG. 1, members may be configured to telescope, slide or otherwise move linearly (i.e. move along an axis rather than about an axis), or be configured to move along paths other than curved paths. For example, the mount 24 may be configured to move about the “x” axis, such as to permit the display to be tilted up and down, to move about the “y” axis, such as to permit the display to be swiveled from side to side, and to simply move along the “z” axis, such as to permit the display to be moved in and out (such as towards or away from a wall/viewer).

The robot 24 might have various other configurations. For example, the robot 24 might have one arm or multiple arms, it might have multiple rotating portions and the like. The particular configuration of the robot 24 may differ depending upon the desired use of the robot. As is known, robots may be configured for various uses. For example, the configuration of the robot 24 might vary in a manufacturing setting, such as to be configured to support a paint sprayer, welding head or the like.

Importantly, the robot 24 preferably comprises one or more supports or other portions which are moveable. Means are provided for moving those one or more portions, such as one or more motors. Preferably, movement of the robot 24 is controlled, such as by a controller. The controller might comprise, for example, an electronically or mechanically operated controller.

In a preferred embodiment, the controller may comprise or include a computing device. Various instructions may be provided from the controller to the robot. The controller may generate one more signals or instructions which are transmitted to the robot to cause the robot to move. The signal might comprise, for example, a signal which opens a switch which allows electricity to flow to one or more motors for a predetermined period time which is necessary for the motor to effect the desired movement. In another embodiment, the signal might comprise an instruction which is received by sub-controller of the robot, which sub-controller then causes the robot to move as desired.

In one embodiment, the controller may be configured to cause a robot to move in various patterns or other desired directions. For example, relative to the robotic display 20 illustrated in FIG. 1, the controller might be programmed to cause the display(s) to move in a particular pattern. The controller may be custom-programmed or might be configured to execute pre-set sequences of movement. For example, the display may be configured to move at certain times, into certain positions or in certain patterns, to move with music or the like.

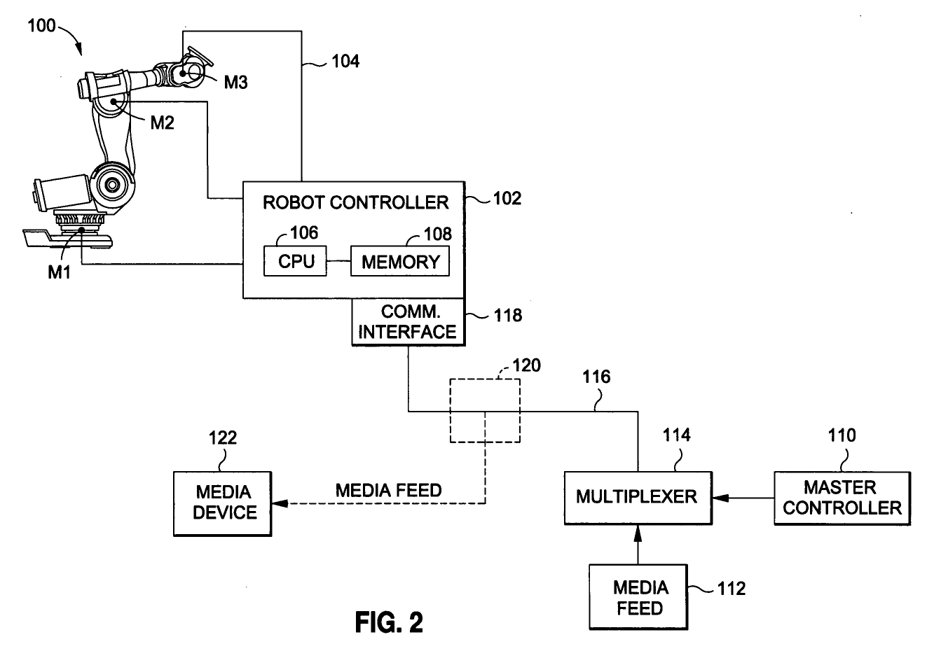

FIG. 2 illustrates one embodiment of a system of the invention. As illustrated, a robot 100 has various portions that are moveable by a first motor M1, a second motor M2 and a third motor M3. The motors are controlled by a main controller 102. The controller 102 may communicate with the robot 100 via one or more communication links 104, which links may be wired or wireless. For example, the controller 102 might comprise a desk-top computer running a control program. The desk-top computer might transmit signals via a RS-232 communication link including a wired pathway to the motor or controller of the robot. Alternatively, the desk-top computer and robot controller might both include wireless transceivers. In this manner, the controller 102 and robot 100 may be located remotely from one another. The controller 102 might also be mounted in or be a part of the robot 100 itself, whereby the user does not need a separate computer in order to provide or execute control instructions to control the robot (i.e. the controller maybe “built-in”).

The form of the communication links 104 and the nature of the communications may vary. For example, the controller 102 might be configured to send an electrical signal that opens or closes a switch to cause a motor to operate or stop. In such an embodiment, the links 104 preferably comprise wired links. In other embodiments, however, the motors might be powered and have internal switches. In such an embodiment, the controller 102 might be configured to send a simple digital or analog signal that instructs the switch to open or close.

In one embodiment, the controller may include a processing unit 106 capable of executing machine readable code or “software.” As indicated, that software may comprise a set of instructions which, when executed, cause the controller to move the robot in a predetermined motion or pattern, randomly or otherwise. The software might also or instead simply comprise a set of instructions which permits a user to provide manual input to cause a display or displays to move, either in direct response thereto or to generate a “programmed” movement (which may be implemented immediately or be stored for implementation at a later time). The software or instructions might be stored in one or more data storage or “memory” devices 108 (such as RAM, ROM, EPROM, a hard drive or other devices now known or later developed). In another embodiment, robot control instructions may comprise data or data sets which are utilized by such software or hardware to control the robot (such as a series of data points representing positions or movements which, when the data points are provided to control software, allow the control software to move the robot in the desired manner).

In one embodiment, instructions might be manually input into the controller 102. For example, the controller 102 might comprise a keyboard and a display and be configured to permit a user to input instructions thereto via the keypad. Of course, various graphical user interfaces or the like may be displayed via the display to facilitate such input.

A particular aspect of the invention comprises a method and system for providing robot control instructions.

In one embodiment, robot control instructions are provided in the form of a signal provided to the robot 100 or its controller 102. In one embodiment, this signal comprises a base signal and the one or more robot control instructions.

One embodiment of the invention is illustrated in FIG. 2. As illustrated, robot control instructions (such as data points or machine readable/executable code) may be generated at a master controller 110. The master controller 110 might be located remote from the robot 100. The instructions 110 are associated with a carrier signal. In one embodiment, for example, the carrier signal may comprise a media feed 112. The media feed 112 might comprise, for a example, a television signal (video data and/or a video and audio feed and may comprise still or motion images) or the like. The media feeds/signal 112 might have various forms, including analog or digital.

In one embodiment, the robot control instructions may be associated with the media feed, such as via a multiplexer 114. Again, the multiplexer 114 might work in various fashions, such to integrate the instructions at a different frequency for an analog configuration or to embed the data in the case of a digital signal.

The combined data is transmitted over a communication link 116. For example, if the carrier signal is a media feed, the communication link 116 might comprise a cable television network which includes wireless and wired communication links. The communication link 116 might comprise or include other networks or links, such as the Internet, satellite or cellular phone communication links/paths. For example, the communication link 116 might comprise a satellite television network such as the DISH® or DIRECT TV® networks. Of course, the communication link 116 (such as the above-described networks) may include a variety of communication links, such as wired links to satellite transmitters/receivers, wireless repeaters and the like. The data may be transmitted in various forms over such links, including analog and digital, encoded/encrypted and in other forms.

The data is preferably provided to the robot 100, such as to the controller 102 thereof. As illustrated, the controller 102 may have a communication interface 118. This interface 118 may be configured to receive the signal and to obtain the robot control instructions carried by or included in the signal. The interface 118 may include, for example, a de-multiplexer for obtaining the robot control instructions from the multiplexed signal. The controller 102 may then, for example, store the instructions in the memory 108 and execute them to control the robot 100.

In one embodiment, the system may include a main de-multiplexer 120. The de-mutliplexer 120 may separate the multiplexed signal and transmit the robot control instructions to the robot controller 102. The de-multiplexer 120 may transmit the media feed 112 to a media device 120. For example, if the media feed 112 comprise a video feed, the video information may be provided to an electronic video display.

Various aspects of the invention will now be appreciated. First, the system can be used to transmit robot control instructions from a remote location to a single robot or multiple robots. For example, a particular store that operates a robotically controlled display might desire to have the robot re-programmed to move the display in a new motion. The store might contact a central service that programs a new set of control instructions and then transmits those instructions to the store. In this manner, the store does not have to be responsible for attempting to program or re-program the robot directly.

In addition, the system permits instructions to be sent or “broadcast” to multiple locations at the same time. For example, robotic displays might be utilized at a plurality of casinos belonging to the same company. The company may generate a new set of robot control instructions at the headquarters thereof and then broadcast those instructions to the multiple casinos (at different locations remote from the headquarters, for example) at the same time, thus effectively re-programming the robots at all of those locations at the same time. The instructions may be coded so that they are specific for each different robot (such as by tagging instructions for particular robots using a robot ID or the like) or cause all of the robots to be programmed to move/operate in the same manner.

A particular advantage of using an existing media feed as a carrier and communication path is that robot control instructions can be provided over an existing high bandwidth link. This permits the instructions to quickly and effectively reach their destination at low cost.

As indicated, in a preferred embodiment of the invention, a robot may be used in conjunction with a media device. In one embodiment, the robot may move the media device. In other embodiments, the robot may simply be located in an environment including such a device. For example, in a store a robot may be configured to move a mount which supports products for sale. Video displays or audio devices may be located in the store to enhance the marketing effect of the robot. In one embodiment, the movement of the robot may be synchronized with the media. For example, the robot may move synchronously with certain audio or video images.

In accordance with the embodiment, the robot control instructions and the associated media may be provided from a remote location to the robot as part of one signal or feed. As illustrated in FIG. 2, the media feed and robot control instructions are multiplexed and transmitted together. This allows, for example, a chain store owner to generate a signal feed which can be transmitted to a host of stores at the same time. Each location which receives the combined feed can then use the media feed at their media device(s) and the robot control instructions to control their robot(s).

In the embodiment illustrated the local robot controller 102 controls only the robot. However, the local controller 102 might also be configured to control or interface with the one or more media devices. In such an embodiment, the controller 102 might include the multiplexer and one or more outputs or ports through which the separated media feed may be output to the media device(s).

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A method of controlling a robot comprising the steps of:
generating robot control instructions at a first location;
associating the robot control instructions with media data;
transmitting the media data including robot control instructions via one or more communication links to a remotely located robot; and
utilizing the robot control instructions to control the robot.

2. The method in accordance with claim 1 including the step of multiplexing said robot control instructions with said media data.

3. The method in accordance with claim 1 wherein said media data comprises a video feed.

4. The method in accordance with claim 1 wherein said one or more communication links comprise a cable television distribution network.

5. The method in accordance with claim 1 wherein said robot is configured to move at least one video display and said media data is utilized by said at least one video display to present video information.

6. The method in accordance with claim 1 wherein said robot has a base and at least one moveable support.

7. The method in accordance with claim 6 wherein said robot further comprises at least one motor configured to move said at least one moveable support.

8. The method in accordance with claim 6 wherein said robot is configured to move an object supported by the robot in at least three dimensions.

9. A robot control system comprising:
a robot controller;
a master controller configured to generate robot control instructions;
a multiplexer for multiplexing said robot control instructions and media data; and
a communication link between said multiplexer and said robot controller comprising at least an existing media distribution network.

10. The robot control system in accordance with claim 9 further comprising a de-multiplexer associated with said robot controller for
de-multiplexing said robot control instructions from said media data.

11. The robot control system in accordance with claim 9 wherein said media data comprises a multi-media audio and video feed.

12. The robot control system in accordance with claim 9 wherein said master controller is located remote from said robot controller.

13. The robot control system in accordance with claim 9 wherein said robot controller comprises a memory for storing robot control instructions and a processor configured to utilize said instructions to generate one or more output signals for controlling a robot.

14. The robot control system in accordance with claim 9 wherein said robot control instructions comprise position data.

15. The robot control system in accordance with claim 9 wherein said media distribution network comprises a cable television network.
